(19) United States
(12) Patent Application Publication
(10) Pub. No.: US 2025/0091677 A1
(43) Pub. Date: Mar. 20, 2025

(54) LUBRICANT SUPPLY SYSTEM FOR A MOTOR VEHICLE

(71) Applicant: KTM AG, Mattighofen (AT)

(72) Inventors: Maria LUTSCH, Helpfau-Uttendorf (AT); Sebastian FAISTAUER, Obertrum am See (AT)

(21) Appl. No.: 18/887,448

(22) Filed: Sep. 17, 2024

(30) Foreign Application Priority Data
Sep. 19, 2023 (AT) A 50760/2023

(51) Int. Cl. B62J 31/00; F01M 1/02; F01M 1/10; F01M 11/03; F16H 57/04

(52) U.S. Cl. CPC B62J 31/00; F01M 1/02; F01M 1/10; F01M 11/03; F16H 57/0436; F01M 2001/0238; F01M 2011/035

(57) ABSTRACT

A lubricant supply system for a motor vehicle, in particular a single-track motor vehicle, includes a lubricant pump configured to convey a lubricant for lubricating engine components in a lubricant circuit of the motor vehicle, and optionally a lubricant filter configured to filter the lubricant conveyed in the lubricant circuit. The lubricant filter is directly attached to the lubricant pump, and/or an imaginary continuation of a pump shaft of the lubricant pump crosses the lubricant filter, and/or at least two lubricant pumps are provided, and the at least two lubricant pumps are driven by a common pump shaft.

### BACKGROUND OF THE INVENTION

The present invention relates to a lubricant supply system for a motor vehicle, in particular a single-track motor vehicle.

Generic lubricant supply systems comprise:
at least one lubricant pump, which is formed to convey a lubricant for lubricating engine components in at least one lubricant circuit of the motor vehicle, and
optionally a lubricant filter, which is formed to filter the lubricant conveyed in the lubricant circuit.

In known systems of the state of the art, a lubricant is conveyed to the different engine components, which lubricant serves to lower friction between the engine components during running operation, and thus to reduce wear.

Lubricant is thus used, for example, to
carry out a lubrication between a piston and a cylinder (or a cylinder liner),
lubricate a transmission system, or
supply a necessary lubrication to other components of the single-track motor vehicle.

After the lubricant has been used to implement a lubrication, it accumulates mostly at particular points, such as for example in a crankcase, from which the lubricant is removed by suction again via at least one lubricant pump and fed back, via the lubricant circuit, to the engine component for lubrication.

In this lubricant circuit, usually after it has been sucked in by the lubricant pump, the lubricant passes through a lubricant filter, in which foreign substances are removed from the lubricant and the latter is prepared for further use again.

However, a disadvantage of the known systems of the state of the art is that, because of the restricted installation spaces (above all with respect to single-track motor vehicles), the distances between the individual components of the lubricant supply system are usually very long. As a result, an increased expenditure of energy is necessary for the at least one lubricant pump, which has to compensate for power losses which occur due to the long line systems, and/or the required volume of oil leads to a deficiency in terms of environmental technology.

A further disadvantage is the relatively long start time when the motor vehicle is started, as it can take longer amounts of time, due to the long line distances, until the engine components are supplied with lubricant (which leads to an increased wear).

### SUMMARY OF THE INVENTION

The object of the present invention is therefore to provide a lubricant supply system and a crankcase and motor vehicle with such a lubricant supply system which at least partially rectify the above-named disadvantages of the state of the art and/or allow a system with a more compact structure and/or allow a more efficient operation and/or represent an ecological and/or economic improvement.

This object is achieved according to the invention by a lubricant supply system for a motor vehicle, in particular a single-track motor vehicle, a crankcase with such a lubricant supply system, as well as a motor vehicle with such a lubricant supply system.

According to the invention, a lubricant supply system for a motor vehicle comprises the following:
at least one lubricant pump, which is formed to convey a lubricant for lubricating engine components in at least one lubricant circuit of the motor vehicle, and
optionally a lubricant filter, which is formed to filter the lubricant conveyed in the lubricant circuit.

The lubricant filter is directly attached to the at least one lubricant pump, and/or
an imaginary continuation of a pump shaft of the at least one lubricant pump crosses the lubricant filter, and/or
at least two lubricant pumps are provided, wherein the at least two lubricant pumps are driven by a common pump shaft.

As part of a first aspect of the invention, it is thus provided that the lubricant filter is directly attached to the at least one lubricant pump.

This can be understood such that the housing of the at least one lubricant pump and the housing of the lubricant filter are in direct contact or are even formed by a common component. As a result, the distance that the lubricant has to cover between the at least one pump and the lubricant filter is shortened to a minimum. Thus, the power loss for the pumped distance between the at least one lubricant pump and the lubricant filter is almost eliminated, and the “lost” volume of lubricant through the line can likewise be reduced to a minimum.

In a second aspect of the present invention, the imaginary continuation of a pump shaft of the at least one lubricant pump crosses the lubricant filter.

By dint of this second aspect, the distances for the conveyed lubricant between at least one lubricant pump and lubricant filter can also be reduced to a minimum through the arrangement of the lubricant filter relative to the at least one lubricant lump. As a result, both the required volume of lubricant for the lubricant supply and the power losses for moving the lubricant in the lubricant lines can again be reduced.

As part of a third aspect, at least two lubricant pumps are provided, and the at least two lubricant pumps are driven by a common pump shaft.

In most motor vehicle lubricant supply systems, the lubricant supply is implemented by at least two lubricant pumps. A suction pump and a high-pressure pump usually divide the lubricant system, and each supply to different components. It is common in the state of the art to position these two lubricant pumps in separate positions (depending on the engine components to be supplied to). However, two different drive systems also become necessary for the lubricant pumps.

As part of the third aspect of the present invention, however, a common drive system can be implemented via a pump shaft common to the at least two lubricant pumps, as a result of which the installation space can be substantially reduced via the omission of at least one drive unit and the at least two lubricant pumps can furthermore be driven in a more energy-efficient and effective manner.

The mentioned aspects of the invention have in common the fact that a more compact lubricant system can be created which can be constructed with a small installation space, in particular in single-track vehicles, at desired or optimal points of the vehicle (for example underneath a piston-cylinder unit, a crankshaft and/or a drive transmission and/or transverse to the direction of travel in the case of a single-track vehicle), without generating longer line distances.

Due to the more efficient and more effective possibility of operating a lubricant supply system, not only does the expenditure of energy to be allowed for to operate such a system decrease, but fewer means can also be anticipated in the design of a corresponding system, as a result of which a smaller installation space can be reached, which is in any case to be continuously reduced in most, in particular single-track, motor vehicles.

Furthermore, both the ecological and the economic aspect can of course be improved by the more efficient usage.

A further positive aspect of the present invention is that the distances for the lubricant can also be shortened through the more compact construction, as a result of which there is a reduced volume of lubricant in the lubricant supply system. This reduced volume not only reduces the production effort in terms of manufacturing technology, but also lowers the required volume of lubricant during operation of the motor vehicle. Thus, smaller volumes of old lubricant need to be disposed of during servicing-which is associated with a lubricant change—as well, whereby not only the economic but also the ecological aspect can in turn be improved.

However, due to the reduction in the installation volume of the lubricant system, the installation volume obtained can be used to increase the volume of lubricant, as a result of which service intervals can be increased and thus a lubricant change needs to be carried out less often.

Furthermore, due to the reduction in the volume of lubricant and/or the shortening of the line system of the lubricant supply system, lubricant can be conveyed to the engine components very quickly when the motor vehicle is started. As a result, a very quick lubrication of the engine components ensues, which leads in turn to reduced wear and to a reduced noise level when the motor vehicle is started.

This reduced noise level when the motor vehicle is started can be attributed to the fact that, for example, a chain tensioner which is supplied by the lubricant is already supplied with lubricant within a few revolutions of the crankshaft, and thus a low-noise operation of the motor vehicle ensues.

Due to the reduced number of component parts and the shortened line distances of the lubricant circuit, the processing effort during manufacture as well as the number of seals of the lines can also be reduced. As a result, a process reliability during manufacture increases and the risk of leaks during operation of the lubricant supply system decreases substantially.

A further advantage of the reduced number of component parts is the significant weight reduction.

By single-track motor vehicles may be meant for example motorbikes, motor scooters, mopeds, motor-assisted bicycles or the like.

A system according to the invention need not necessarily be produced through a production of a new motor vehicle. A corresponding system can also be implemented for example in existing motor vehicles—such as were described for example in the introduction to the description—and can thus be retrofitted later.

The phrase “the lubricant filter is directly attached to the at least one lubricant pump” may mean that, for example, a housing of the lubricant pump is in direct contact with a housing of the lubricant filter, or they are formed by the same component part.

The phrase “an imaginary continuation of the pump shaft crosses the lubricant filter” may mean that, for example, a cylindrical imaginary or virtual continuation of the pump shaft intersects or crosses the lubricant filter. The pump shaft and the lubricant filter have a coaxial longitudinal axis.

In preferred embodiments, however, a small offset between the longitudinal axes of the pump shaft and the lubricant filter can be provided, for example in order to guarantee an easy and simply constructed transfer of the lubricant from the at least one pump into the lubricant filter.

The phrase “a common pump shaft is provided for at least two lubricant pumps” may mean that, for example, a single-piece shaft drives the lubricant pumps. Naturally, pump shaft can naturally also have several component parts which are connected to each other in a rotationally movement-locking manner—preferably in a completely movement-locking manner—for example in a material-bonding, positive-locking and/or friction-locking manner.

The at least one lubricant pump or the at least two lubricant pumps can have a gear pump—preferably a trochoid pump.

The filter housing of the lubricant filter can be formed by an opening of a crankcase.

The at least one lubricant pump or the at least two lubricant pumps can be positioned in a corresponding opening of a crankcase.

The opening can be a blind hole, optionally with a floor-side feed opening for lubricant, wherein the blind hole is formed substantially cylindrical (particularly preferably with a circular base) or is adapted in another way to a shape of the actual filter material.

Preferably, the at least one lubricant pump and the lubricant filter are connected fluidically through at least one opening (see above, feed opening)—preferably an opening of a crankcase, particularly preferably a drilled hole in the crankcase.

The at least one lubricant pump and the lubricant filter can be connected through at least one opening of a crankcase, which opening is already implemented by a casting process used to produce the crankcase. Through the production of the opening in the casting process—for example—any type of cross-section geometries can thus be implemented.

Through the formation of the filter housing as a crankcase and the arrangement of the lubricant pump or the at least two lubricant pumps in the crankcase, the crankcase can thus form a common housing. As a result, the at least one lubricant pump can be connected to the lubricant filter merely through a corresponding opening of the crankcase or a drilled hole of the crankcase. Thus, the length of a fluid line between lubricant pump and lubricant filter can be maximally reduced to an opening.

The lubricant can preferably be represented by a commonly used engine oil.

A first lubricant pump of the at least two lubricant pumps can be formed as a suction pump and/or a second lubricant pump of the at least two lubricant pumps can be formed as a high-pressure pump.

Preferably, the, preferably first, lubricant pump is formed to suck the lubricant out of a crankcase via a feed channel.

Preferably, the, preferably first, lubricant pump is formed to pump the lubricant in a first supply channel leading into a transmission housing.

The first supply channel can be, for example, a low-pressure supply channel.

The, preferably second, lubricant pump can be formed to suck the lubricant out of a transmission housing via a feed channel.

Preferably, the, preferably second, lubricant pump is formed to pump the lubricant into a second supply channel leading into a crankcase.

The second supply channel can be formed for example as a high-pressure supply channel. This can be used to lubricate moving components of the crankcase, in particular, of the internal combustion engine of the motor vehicle, which preferably have direct contact with the combustion, such as for example the piston, the piston rings, the clutch, the chain tensioner, the cylinder head, the piston nozzles or the crankshaft.

The at least one lubricant pump or the at least two lubricant pumps is or are driven by the pump shaft, which pumps are preferably movement-coupled to a crankshaft-particularly preferably via a single-stage and/or multi-stage gear train.

Preferably, an axis of rotation of the at least one lubricant pump or of the at least two lubricant pumps on the one hand and a longitudinal axis of the lubricant filter on the other hand (in particular taking account of manufacturing inaccuracies and assembly inaccuracies) are aligned parallel to each other.

Furthermore, protection is sought for a crankcase of a motor vehicle, in particular a single-track motor vehicle, with a lubricant supply system according to the invention, preferably wherein the lubricant supply system is arranged underneath a piston-cylinder unit, a crankshaft and/or a drive transmission of the motor vehicle.

An opening of the crankcase forms the housing of the lubricant filter, and a lubricant filter cover on the crankcase preferably transfers the lubricant filtered through the lubricant filter from the lubricant filter, particularly preferably into a second supply channel of the crankcase. The lubricant filter cover can preferably have a channel section for this transfer function.

Preferably, the, preferably first, lubricant pump is formed to suck the lubricant out of a crankcase via a feed channel, and the feed channel is arranged in the crankcase such that lubricant is conveyed directly to the feed channel from a crankshaft by an oil scraper.

Protection is likewise sought for a motor vehicle, in particular, a single-track motor vehicle, with a lubricant supply system according to the invention.

### BRIEF DESCRIPTION OF THE DRAWINGS

Further details and advantages of the present invention are explained in more detail in the following description with the aid of the drawings, in which:

FIGS. 1 to 6 show an embodiment according to the invention of a lubricant supply system in the state when installed in a drive unit of a single-track motor vehicle,

FIGS. 7 to 10 show the embodiment of the lubricant supply system from FIGS. 1-6 in isolation,

FIGS. 11 to 14 show a further embodiment of a lubricant supply system according to the invention, and

FIG. 15 shows a single-track motor vehicle with an embodiment according to the invention of a lubricant supply system.

### DETAILED DESCRIPTION OF THE INVENTION

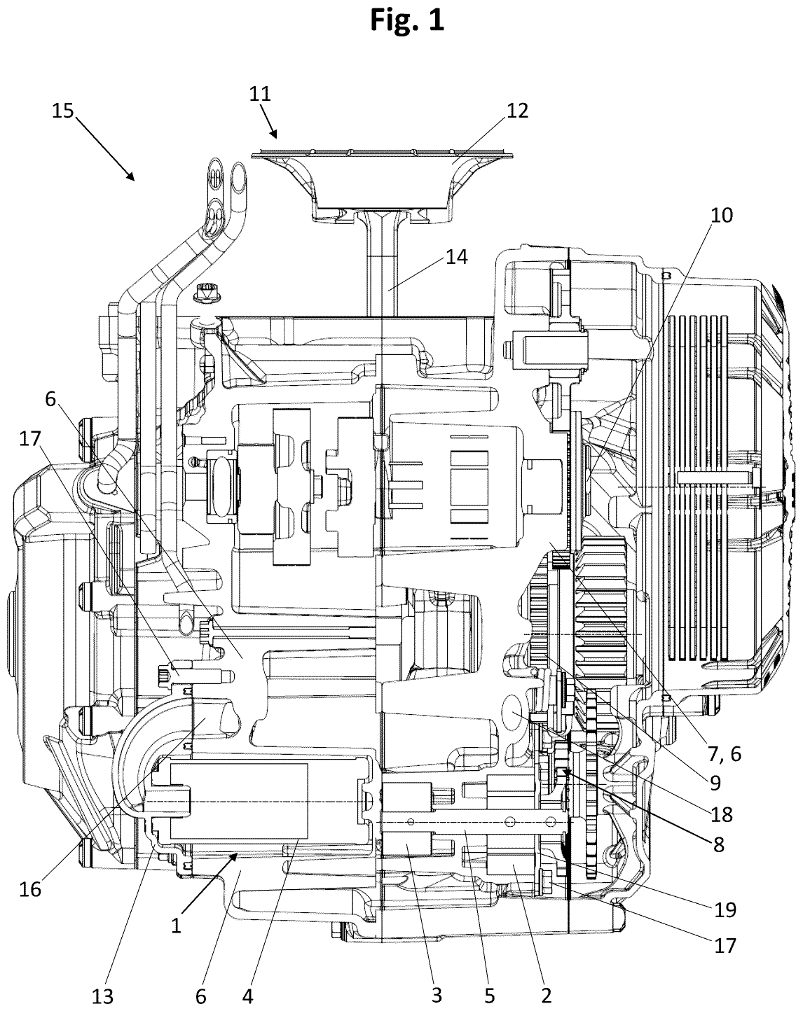

FIGS. 1 to 6 show a first embodiment according to the invention of a lubricant supply system 1 in the state when installed in a drive unit 15 of a single-track motor vehicle 20, wherein a cross section through the entire drive unit 15 is represented in FIG. 1, in which cross section the lubricant supply system 1 is visible.

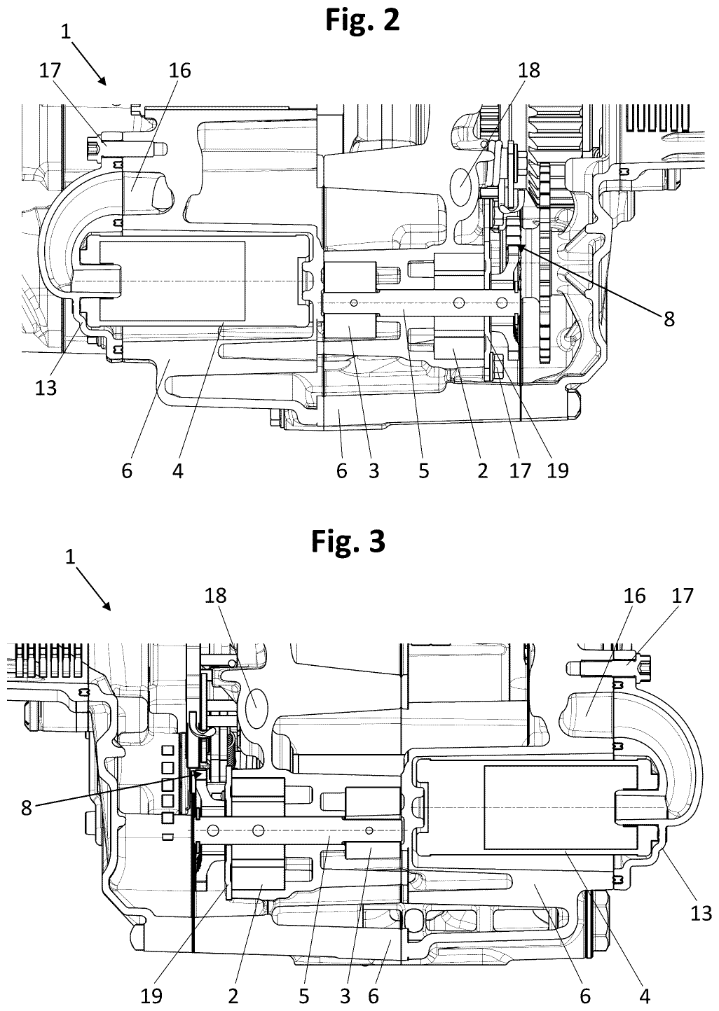

A detail view of the lubricant supply system 1 from FIG. 1 is represented in FIG. 2.

FIG. 3 shows a view of the same cross section as in FIGS. 1 and 2, but from the opposite viewing direction.

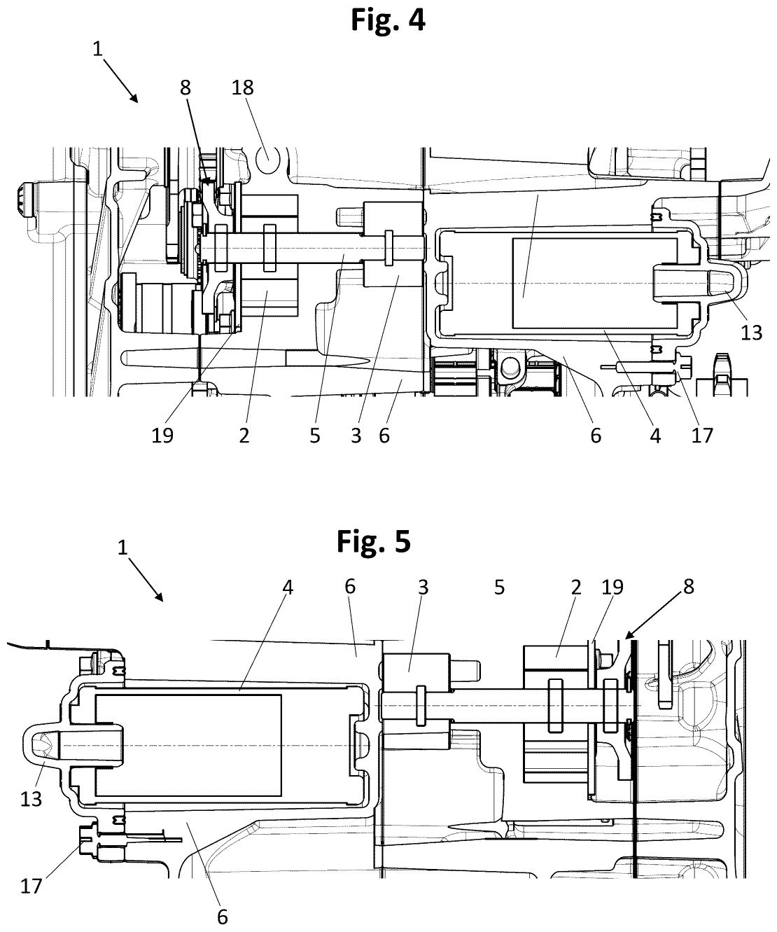

FIGS. 4 and 5 show further sectional representations of the embodiment of FIGS. 1 to 3 of the first embodiment of a lubricant supply system 1, wherein FIG. 4 represents a sectional plane normal to FIGS. 1 to 3, wherein the view from below is shown, and FIG. 5 shows the same sectional plane as FIG. 4, but a view from above.

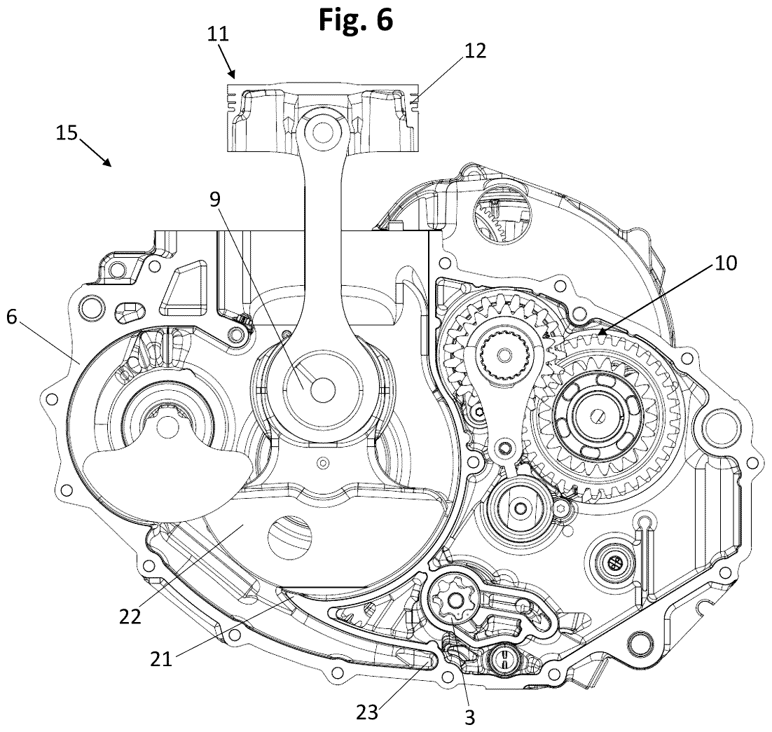

FIG. 6 shows a sectional representation normal to the representations of FIGS. 1 to 5.

It follows from FIGS. 1 to 6 that the lubricant supply system 1 has two lubricant pumps 2, 3, which are driven by a common pump shaft 4.

In this embodiment the lubricant pumps 2, 3 are implemented as gear pumps-strictly speaking: trochoid pumps—wherein the inner trochoid pump gear is driven by a rotation of the pump shaft 5.

The pump shaft 5 is in turn driven via a multi-stage gear train 8, which is movement-coupled directly to the crankshaft 9.

The drive unit 15 shown in this embodiment for the single-track motor vehicle 20 is implemented by an internal combustion engine, which has a piston-cylinder unit 11 (not represented in its entirety for the sake of clarity), wherein the piston 12—represented cut—of the piston-cylinder unit 11 is fastened to the crankshaft 9 in a known way via the connecting rod 14.

The first lubricant pump 2 of this embodiment is implemented as a suction pump, wherein lubricant is removed directly from the crankcase 6 by suction by this first lubricant pump 2 after the lubricant has been scraped off the crankshaft 9—strictly speaking: off a piston counterweight 22 of the crankshaft 9—for example via an oil scraper 21.

It can advantageously be provided that the feed channel of the first lubricant pump 2 branches off in the crankcase 6 at a position 23 at which the lubricant is conveyed by the oil scraper 21 and the movement of the crankshaft 9 (regarding this see FIG. 6).

After the lubricant has been removed from the crankcase 6 by suction by the first lubricant pump 2 via the feed channel, it is conveyed by the first lubricant pump 2 further via the supply channel 18 into the transmission housing 7.

This transmission housing 7 is implemented in a single piece with the crankcase 6 in this embodiment.

Coming from the supply channel 18, the lubricant is released from “above” over the drive transmission 10 of the single-track motor vehicle 20, wherein the lubricant flows down over the drive transmission 10 due to gravity, and thus lubricates the drive transmission 10.

The lubricant then accumulates again in a lower region of the transmission housing 7, from which the lubricant is removed from the transmission housing 7 by suction by the second lubricant pump 3—which is formed as a high-pressure pump—via a feed channel.

The lubricant conveyed out of the transmission housing 7 and pressurized by the second lubricant pump 3 is then conveyed by the second lubricant pump 3 into a lubricant filter 4 directly attached to the second lubricant pump 3, through which the lubricant is filtered, has contaminants removed from it and is prepared.

The lubricant filter 4 is arranged in such a way that it is crossed by an imaginary continuation of the pump shaft 5.

It is to be recognized that the conveying distance between second lubricant pump 3 and lubricant filter 4 can be reduced to a minimum through this design.

The lubricant circuit can be kept very short through this shortening, as a result of which the lubricant can be conveyed to the engine components to be lubricated quickly and with low loss.

This leads to an energy saving, as only very small pressure losses arise.

Furthermore, lubricant volume can be saved and lubricant can be conveyed to the engine components very quickly when the drive unit 15 is started, as a result of which a very quick lubrication of the engine components ensues, which in turn leads to a reduced wear and to a reduced noise level when the drive unit 15 is started.

This reduced noise level when the drive unit 15 is started can be attributed to the fact that for example a chain tensioner which is lubricated by the lubricant is already supplied with lubricant within a few revolutions of the crankshaft 9, and thus a low-noise operation of the drive unit 15 ensues.

After being filtered through the lubricant filter 4, the lubricant pressurized and conveyed by the second lubricant pump 3 is pumped into a second supply channel 16 via the lubricant filter cover 13.

The specific geometric design of the lubricant filter cover 13 is to be highlighted, through the design of which it is made possible to reduce the installation space further as the lubricant filter cover 13 represents a part of the lubricant circuit and directs the lubricant flow into the second supply channel after passing through the lubricant filter 4.

Furthermore, the stream of the lubricant can be particularly optimized in terms of flow due to the specifically represented design of the lubricant filter cover 13.

The second supply channel 16 supplies to different engine components of the drive unit 15, which are lubricated by the lubricant in their movement during operation of the drive unit 15 or are supplied to due to a lubricant pressure.

Such engine components which are supplied to by the second supply channel 16 are for example the piston-cylinder unit 11, a clutch, a chain tensioner, a crankshaft, a cylinder head, a piston nozzle, etc.

After it has been used to lubricate the engine components, the lubricant accumulates again in the crankcase 6 and is again sucked out of the crankcase 6 by the first lubricant pump 2 and its feed line and fed to the transmission housing 7 to lubricate the drive transmission 10.

As is apparent from FIGS. 1 to 6, the filter housing of the lubricant filter 4 is formed by the crankcase 6.

The lubricant pumps 2, 3 are also positioned in corresponding openings of the crankcase 6.

The supply lines, feed lines and connecting lines (for example of the second lubricant pump 3 to the lubricant filter 4) are formed by corresponding openings, drilled holes and channels of the crankcase 6.

The installation space of the lubricant supply system can be substantially minimized through the implementation of the lubricant supply system 1 in a substantially linear arrangement, which is what follows from FIGS. 1 to 6.

This decrease in size makes it possible to arrange the lubricant supply system 1 transverse to a direction of travel of a single-track motor vehicle 20.

A further advantage of this minimized installation space is that the lubricant supply system 1 can be positioned underneath the engine components almost at the lowest end of the drive unit 15, as a result of which a suction height of the lubricant from the crankcase 6 to the first lubricant pump 2 or to the second lubricant pump 3 decreases, as a result of which the drive power of the lubricant supply system 1 is in turn reduced and the volumes of the lines as well as the distances which the lubricant has to cover become smaller.

Furthermore, through the specific positioning of the lubricant filter 4 directly adjacent to the lubricant pump 3, the possibility arises that the transfer of the lubricant to the lubricant filter 4 can be carried out over the shortest distance with a very large inflow cross section.

A further advantage of this specific positioning is that the supply channels 16, 18 of the engine components 9, 10, 11, 12, 14 can also be implemented by one or more central supply drilled holes, which can be implemented with relatively short lengths, which in turn leads to shortened supply distances.

Due to the shortening of the line distances of the lubricant circuit, the lubricant reaches the consumers quickly and with low losses.

The pressure buildup is achieved in a very short time, as a result of which a pressure buildup can be produced more quickly and as a result of which in turn the wear of the component parts is reduced.

The volumes of lubricant and the number of component parts can also be lowered, which results in a significant weight reduction.

Due to the reduced number of component parts and the shortened line distances of the lubricant circuit, the processing effort during manufacture as well as the number of seals of the lines can also be reduced, as a result of which a process reliability during manufacture increases and the risk of leaks during operation of the lubricant supply system 1 decreases substantially.

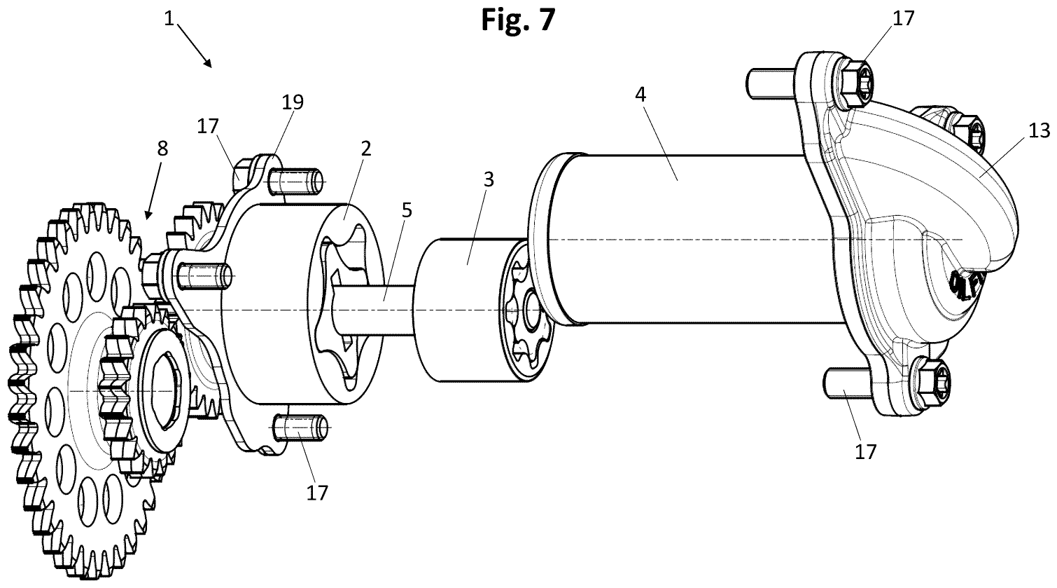

FIGS. 7 to 10 show the embodiment of the lubricant supply system 1 from FIGS. 1 to 6 in isolation.

A perspective view of the multi-stage gear train 8, the pump shaft 5 attached thereto, the lubricant pumps 2, 3, the lubricant filter 4 and the lubricant filter cover 13 is shown in FIG. 7.

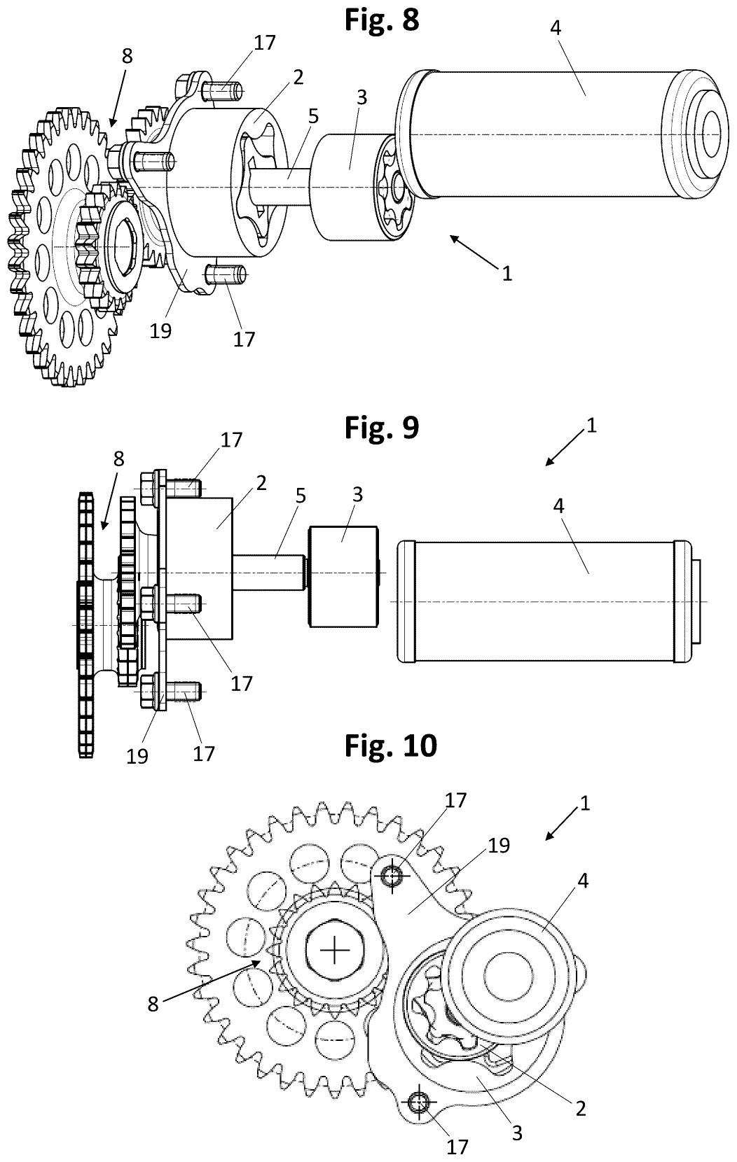

FIG. 8 shows a further perspective view of these components, wherein the lubricant filter cover 13 is not represented, however, in order to increase clarity.

Projected views of FIG. 8 are represented by FIGS. 9 and 10.

It is to be recognized that the lubricant filter 4 and the pump unit with the lubricant pumps 2, 3 represent separate component parts which are inserted in the crankcase 6, 7 from opposite sides.

For this, the lubricant filter 4 is pushed into a corresponding opening of the crankcase 6, wherein this opening is sealed via the lubricant filter cover 13.

The lubricant filter cover 13 is arranged directly on the crankcase 6 via the screw connection 17 and in addition serves to secure the position of and to position the lubricant filter 4.

In a similar way, the pump unit, consisting of the pump shaft 5, the first lubricant pump 2 and the second lubricant pump 3, is also inserted in a corresponding opening of the crankcase 6 and capped and positioned via the pump sealing cover 19.

This pump sealing cover 19 is in turn screwed directly to the crankcase 6 via the screw connections 17.

On the outside of the pump sealing cover 19, the pump shaft 5 is connected rotationally, in a movement-locking manner, to the crankshaft 9 via the multi-stage gear train 8.

The fluid connection of the second lubricant pump 3 and of the lubricant filter 4 is implemented by a corresponding opening in the crankcase 6.

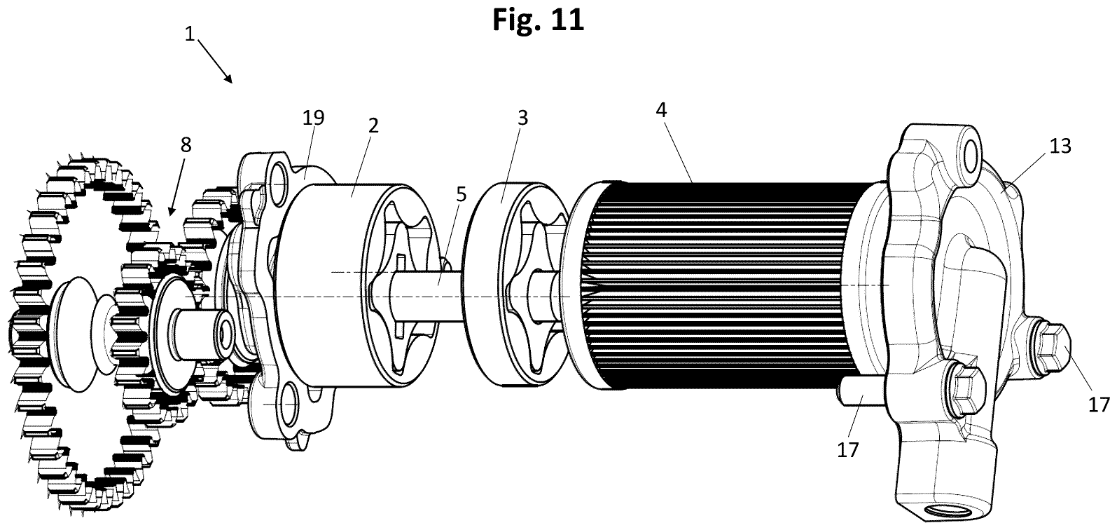

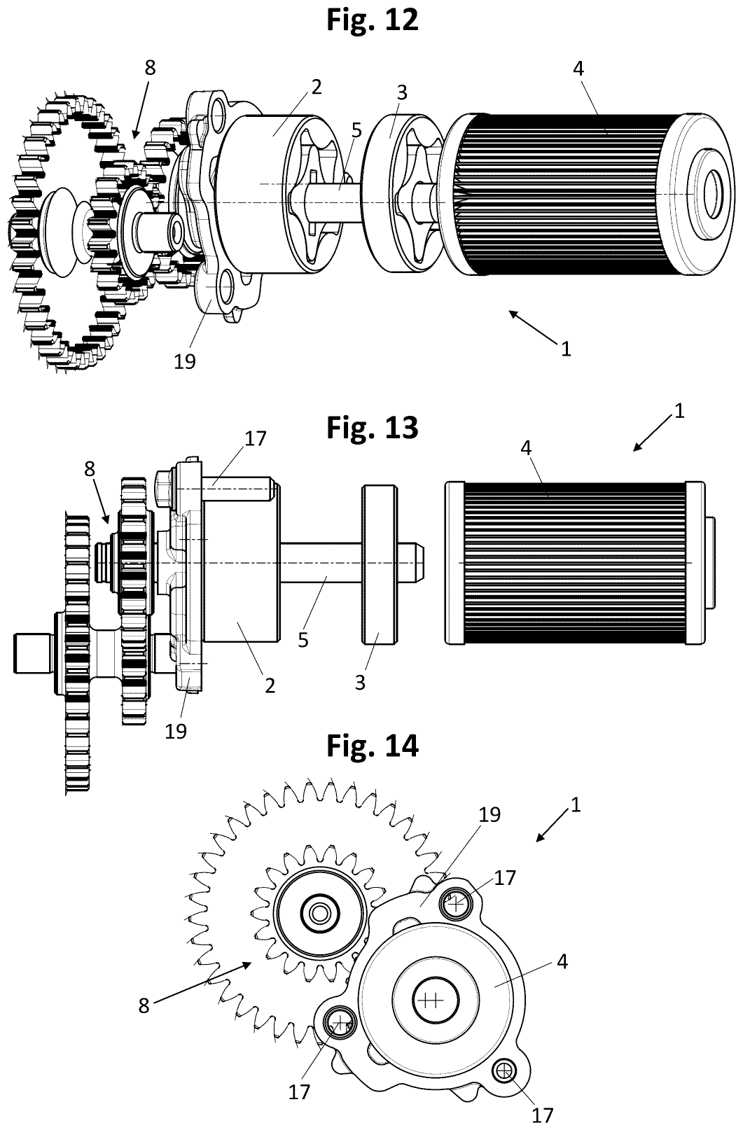

FIGS. 11 to 14 show a further embodiment of a lubricant supply system 1, wherein in turn FIG. 11 represents a perspective view with lubricant filter cover 13, FIG. 12 represents a perspective view without lubricant filter cover 13 and FIGS. 13 and 14 represent projected views of FIG. 12.

The embodiment represented by FIGS. 11 to 14 of the lubricant supply system is substantially similar to the preceding one, but this further embodiment differs by the dimensions of the lubricant pumps 2, 3, the lubricant filter 4, the multi-stage gear train 8 as well as the geometric design of the lubricant filter cover 13.

Nevertheless, the functioning of the further embodiment of FIGS. 11 to 14 of the lubricant supply system 1 is substantially the same as that of the lubricant supply system which was explained by FIGS. 1 to 10.

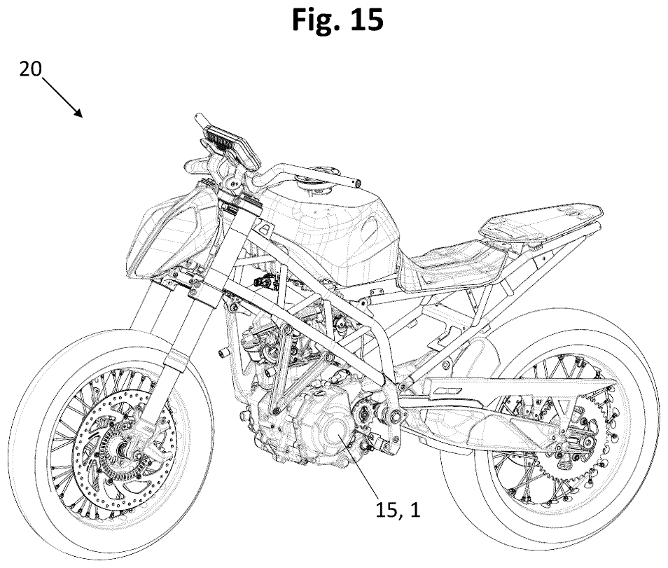

FIG. 15 shows a single-track motor vehicle 20 with a drive unit 15 formed as an internal combustion engine, wherein the drive unit 15 has an embodiment according to the invention of a lubricant supply system 1.

### LIST OF REFERENCE NUMBERS

1 lubricant supply system
2 first lubricant pump (suction pump)
3 second lubricant pump (high-pressure pump)
4 lubricant filter
5 pump shaft
6 crankcase
7 transmission housing
8 multi-stage gear train
9 crankshaft
10 drive transmission
11 piston-cylinder unit
12 piston
13 lubricant filter cover
14 connecting rod
15 drive unit for single-track motor vehicle
16 second supply channel
17 screw connection
18 supply channel
19 pump sealing cover
20 motor vehicle
21 oil scraper
22 piston counterweight
23 position

1. A lubricant supply system for a motor vehicle, in particular a single-track motor vehicle, comprising:
at least one lubricant pump configured to convey a lubricant for lubricating engine components in at least one lubricant circuit of the motor vehicle, and
optionally a lubricant filter formed to filter the lubricant conveyed in the lubricant circuit,
wherein the lubricant filter is directly attached to the at least one lubricant pump, and/or
wherein an imaginary continuation of a pump shaft of the at least one lubricant pump crosses the lubricant filter, and/or
wherein at least two lubricant pumps are provided, and the at least two lubricant pumps are driven by a common pump shaft.

2. The lubricant supply system according to claim 1, wherein the at least one lubricant pump or the at least two lubricant pumps has or have a gear pump, preferably a trochoid pump.

3. The lubricant supply system according to claim 1, wherein the filter housing of the lubricant filter is formed by an opening of a crankcase.

4. The lubricant supply system according to claim 1, wherein the at least one lubricant pump or the at least two lubricant pumps are positioned in a corresponding opening of a crankcase.

5. The lubricant supply system according to claim 1, wherein the at least one lubricant pump and the lubricant filter are connected fluidically through at least one opening, preferably an opening of a crankcase, particularly preferably a drilled hole in the crankcase.

6. The lubricant supply system according to claim 1, wherein a first lubricant pump of the at least two lubricant pumps is formed as a suction pump and/or a second lubricant pump of the at least two lubricant pumps is formed as a high-pressure pump.

7. The lubricant supply system according to claim 1, wherein the, preferably first, lubricant pump is formed to suck the lubricant out of a crankcase via a feed channel.

8. The lubricant supply system according to claim 1, wherein the, preferably first, lubricant pump is formed to pump the lubricant into a first supply channel leading into a transmission housing.

9. The lubricant supply system according to claim 1, wherein the, preferably second, lubricant pump is formed to suck the lubricant out of a transmission housing via a feed channel.

10. The lubricant supply system according to claim 1, wherein the, preferably second, lubricant pump is formed to pump the lubricant into a second supply channel leading into a crankcase.

11. The lubricant supply system according to claim 1, wherein the at least one lubricant pump or the at least two lubricant pumps is or are driven by the pump shaft, which pump shaft is preferably movement-coupled to a crankshaft—particularly preferably via a single-stage gear train.

12. A crankcase of a motor vehicle, in particular a single-track motor vehicle, comprising the lubricant supply system according to claim 1, preferably wherein the lubricant supply system is arranged underneath a piston-cylinder unit, a crankshaft and/or a drive transmission of the motor vehicle.

13. The crankcase according to claim 12, wherein an opening of the crankcase forms the housing of the lubricant filter and a lubricant filter cover on the crankcase preferably transfers the lubricant filtered through the lubricant filter from the lubricant filter, particularly preferably into a second supply channel of the crankcase.

14. The crankcase according to claim 12, wherein the, preferably first, lubricant pump is formed to suck the lubricant out of a crankcase via a feed channel, wherein the feed channel is arranged in the crankcase such that lubricant is conveyed directly to the feed channel from a crankshaft by an oil scraper.

15. A motor vehicle, in particular single-track motor vehicle, with a lubricant supply system according to claim 1.
